(19) United States
(12) Patent Application Publication
(10) Pub. No.: US 2025/0384103 A1
(43) Pub. Date: Dec. 18, 2025

(54) METHOD, APPARATUS, DEVICE AND STORAGE MEDIUM FOR MANAGING DATA PUBLISHING

(71) Applicants: Lemon Inc., Grand Cayman (KY); Beijing Zitiao Network Technology Co., Ltd., Beijing (CN)

(72) Inventors: Yuan Feng, Singapore (SG); Qinxin Wang, Beijing (CN); Jiawei Feng, Beijing (CN); Hongwei Kang, Beijing (CN); Yuzhou Wang, Beijing (CN); Dongming Liu, Beijing (CN); Ruidong Pan, Beijing (CN)

(21) Appl. No.: 19/241,679

(22) Filed: Jun. 18, 2025

Related U.S. Application Data
(63) Continuation of application No. PCT/CN2024/099423, filed on Jun. 14, 2024.

(51) Int. Cl. G06F 16/958; G06F 16/215

(52) U.S. Cl. CPC G06F 16/958; G06F 16/215

(57) ABSTRACT

There are provided methods, apparatuses, devices and storage media for managing data publishing. A publishing goal associated with the data publishing is received, the publishing goal indicating a publishing result expected to be obtained by data publishing. A publishing quantity of a plurality of data items required to be published for achieving the publishing goal is determined. Based on a publishing state of a first set of published data items, a first set of lifecycles of the first set of data items is determined, a first lifecycle in the first set of lifecycles indicating an impact of a first data item in the first set of data items on the publishing goal. A second quantity of a second set of data items to be published is determined based on the publishing quantity, a first quantity of the first set of data items and the first set of lifecycles.

### CROSS-REFERENCE TO RELATED APPLICATIONS

This application claims priority to Patent Application No. PCT/CN2024/099423, filed with the China National Intellectual Property Administration on Jun. 14, 2024, and entitled “METHOD, APPARATUS, DEVICE AND STORAGE MEDIUM FOR MANAGING DATA PUBLISHING”, the disclosures of which are incorporated herein by reference in their entireties.

### FIELD

Example embodiments of the present disclosure generally relate to the field of data publishing, and more particularly, to a method, apparatus, device, and computer-readable storage medium for managing data publishing.

### BACKGROUND

With the progress of computer technology, varieties of applications have been developed, and various types of data may be published in applications, so as to provide users of the applications with multifaceted information. Accurately determining the amount of data to be published helps to evaluate the quality of a data publishing link and the effect of data publishing.

### SUMMARY

In a first aspect of the present disclosure, a method for managing data publishing is provided. The method comprises: receiving a publishing goal associated with the data publishing, the publishing goal indicating a publishing result expected to be obtained by data publishing; determining a publishing quantity of a plurality of data items required to be published for achieving the publishing goal; determining, based on a publishing state of a first set of published data items, a first set of lifecycles of the first set of data items, a first lifecycle in the first set of lifecycles indicating an impact of a first data item in the first set of data items on the publishing goal; and determining a second quantity of a second set of data items to be published based on the publishing quantity, a first quantity of the first set of data items and the first set of lifecycles.

In a second aspect of the present disclosure, an apparatus for managing data publishing is provided. The apparatus comprises: a publishing goal receiving module, configured for receiving a publishing goal associated with the data publishing, the publishing goal indicating a publishing result expected to be obtained by data publishing; a publishing quantity determining module, configured for determining a publishing quantity of a plurality of data items required to be published for achieving the publishing goal; a lifecycle determining module, configured for determining, based on a publishing state of a first set of published data items, a first set of lifecycles of the first set of data items, a first lifecycle in the first set of lifecycles indicating an impact of a first data item in the first set of data items on the publishing goal; and a second quantity determining module, configured for determining a second quantity of a second set of data items to be published based on the publishing quantity, a first quantity of the first set of data items and the first set of lifecycles.

In a third aspect of the present disclosure, an electronic device is provided. The electronic device comprises: at least one processing unit; and at least one memory, coupled to the at least one processing unit and storing instructions executed by the at least one processing unit. The instructions, when executed by the at least one processing unit, cause the device to perform the method according to the first aspect of the present disclosure.

In a fourth aspect of the present disclosure, a computer readable storage medium is provided. The computer readable storage medium stores a computer program thereon, and the computer program may be executed to implement the method according to the first aspect of the present disclosure.

In a fifth aspect of the present disclosure, a computer program product is provided, comprising a computer program, wherein the computer program, when executed by a processor, implements the method according to the first aspect of the present disclosure.

It should be understood that what is described in this Summary is not intended to identify key features or essential features of the implementations of the present disclosure, nor is it intended to limit the scope of the present disclosure. Other features disclosed herein will become easily understandable through the following description.

### BRIEF DESCRIPTION OF THE DRAWINGS

The above and other features, advantages, and aspects of respective implementations of the present disclosure will become more apparent from the following detailed description with reference to the accompanying drawings. The same or similar reference numerals represent the same or similar elements throughout the figures, where:

FIG. 1 illustrates a schematic diagram of an example environment in which embodiments of the present disclosure may be implemented;

FIG. 2 illustrates a schematic diagram of an example according to some embodiments of the present disclosure;

FIG. 3 illustrates a schematic view of an example relationship between a publishing quantity and effect of data according to some embodiments of the disclosure;

FIG. 4 illustrates a schematic diagram of an example relationship between effect and time of data publishing according to some embodiments of the present disclosure;

FIG. 5 illustrates a schematic diagram of an example of obtaining data items according to some embodiments of the present disclosure;

FIG. 6 illustrates a flowchart of a process for managing data publishing according to some embodiments of the present disclosure;

FIG. 7 illustrates a block diagram of an apparatus for managing data publishing according to some embodiments of the present disclosure; and

FIG. 8 illustrates a block diagram of an electronic device in which one or more embodiments of the present disclosure may be implemented.

### DETAILED DESCRIPTION

The embodiments of the present disclosure will be described in more detail with reference to the accompanying drawings, in which some embodiments of the present disclosure have been illustrated. However, it should be understood that the present disclosure may be implemented in various manners, and thus should not be construed to be limited to embodiments disclosed herein. On the contrary, those embodiments are provided for the thorough and complete understanding of the present disclosure. It should be understood that the drawings and embodiments of the present disclosure are only used for illustration, rather than limiting the protection scope of the present disclosure.

As used herein, the term “comprise” and its variants are to be read as open terms that mean “include, but is not limited to.” The term “based on” is to be read as “based at least in part on.” The term “one embodiment” or “the embodiment” is to be read as “at least one embodiment.” The term “some embodiments” is to be read as “at least some embodiments.” Other definitions, explicit and implicit, might be further included below.

As used herein, unless explicitly stated otherwise, performing a step “in response to A” does not mean that the step is performed immediately after “A”, but may include one or more intermediate steps.

It is to be understood that the data involved in this technical solution (including but not limited to the data itself, data acquisition or use) should comply with the requirements of corresponding laws and regulations and relevant provisions.

It is to be understood that, before applying the technical solutions disclosed in respective embodiments of the present disclosure, the user should be informed of the type, scope of use, and use scenario of the personal information involved in the present disclosure in an appropriate manner in accordance with relevant laws and regulations, and user authorization should be obtained.

For example, in response to receiving an active request from the user, prompt information is sent to the user to explicitly inform the user that the requested operation would acquire and use the user's personal information. Therefore, according to the prompt information, the user may decide on his/her own whether to provide the personal information to the software or hardware, such as electronic devices, applications, servers, or storage media that perform operations of the technical solutions of the present disclosure.

As an optional but non-limiting implementation, in response to receiving an active request from the user, the way of sending the prompt information to the user may, for example, include a pop-up window, and the prompt information may be presented in the form of text in the pop-up window. In addition, the pop-up window may also carry a select control for the user to choose to “agree” or “disagree” to provide the personal information to the electronic device.

It is to be understood that the above process of notifying and obtaining the user authorization is only illustrative and does not limit the implementations of the present disclosure. Other methods that satisfy relevant laws and regulations are also applicable to the implementations of the present disclosure.

As used herein, the term “model” may learn an association relationship between respective inputs and outputs from training data such that a corresponding output may be generated for a given input after training is completed. The model may be generated based on machine learning techniques. Deep learning is a machine learning algorithm that processes inputs and provides corresponding outputs by using a multi-layer processing unit. The neural network model is one example of a deep learning based model. As used herein, a “model” may also be referred to as a “machine learning model,” a “learning model,” a “machine learning network,” or a “learning network,” which may be used interchangeably herein.

A “neural network” is a deep learning-based machine learning network. The neural network is capable of processing inputs and providing respective outputs, which typically include an input layer and an output layer and one or more hidden layers between the input layer and the output layer. Neural networks used in deep learning applications typically include many hidden layers, thereby increasing the depth of the network. Respective layers of the neural network are connected in sequence such that the output of the previous layer is provided as an input to the next layer, where the input layer receives the input of the neural network and the output of the output layer serves as the final output of the neural network. Each layer of the neural network includes one or more nodes (also referred to as processing nodes or neurons), each node processing input from the previous layer.

Generally, machine learning may generally include three phases, a training phase, a testing phase, and an application phase (also referred to as an inference phase). At the training phase, a given model may be trained using a large amount of training data, and parameter values are iteratively updated until the model may obtain consistent inferences from the training data that satisfy the expected objectives. By training, the model may be considered to be able to learn from the training data an association (which may also be referred to as an input-to-output mapping) between an input and an output from the training data. Parameter values of the trained model are determined. In the testing phase, a test input is applied to the trained model to test whether the model may provide a correct output, thereby determining performance of the model. The testing phase may sometimes be integrated in the training phase. In the application phase, the trained model may be used to process the actual model input based on the parameter value obtained by training, to determine a corresponding model output.

As previously mentioned, the publishing amount of data may affect a publishing result of the data. Conventionally, it is difficult to accurately determine the publishing amount needed to obtain a target publishing result. In order to obtain the target publishing result, a large quantity of data items are often published, which may lead to a waste of data.

In view of this, according to embodiments of the present disclosure, an improved solution for managing data publishing is provided. According to the solution, a publishing goal associated with the data publishing is received, the publishing goal indicating a publishing result expected to be obtained through the data publishing. A publishing quantity of a plurality of data items to be published for realizing the publishing goal is determined. A first set of lifecycles of a published first set of data items is determined based on a publishing state of the first set of data items, a first lifecycle in the first set of lifecycles indicating an impact of a first data item in the first set of data items on the publishing goal. A second quantity of a second set of data items to be published is determined based on the publishing quantity, a first quantity of the first set of data items and the first set of lifecycles.

Thus, the quantity of data items to be published may be determined based on the lifecycle of the data items already published and the determined to-be-published quantity. This helps to flexibly adjust the quantity of published data, reduce resource waste, and improve the data publishing effect.

FIG. 1 shows a schematic diagram of an example environment 100 in which embodiments of the present disclosure may be implemented. The environment 100 involves a data management platform 110. In the example environment 100, the data management platform 110 may include a plurality of data items 112 (e.g., including data items 112-1, . . . , 112-N1, where N1 is a positive integer greater than 1, hereinafter collectively referred to as the data items 112 for ease of description). The data items 112 may include any suitable type of data item, for example, images, text, audio, video, and the like. The data items 112 may also be referred to as media items, media data, etc.

The data management platform 110 may receive a publishing goal 102 associated with data publishing, and determine a publishing quantity of the plurality of data items 112 to be published, based on the publishing goal 102. The data management platform 110 may publish a plurality of corresponding data items to at least one data publishing platform 120 based on the determined publishing quantity (e.g., including data publishing platforms 120-1, . . . , 120-N2, where N2 is a positive integer, and for ease of description, one or more data publishing platforms are collectively referred to as the data publishing platform 120 hereinafter).

The data items may be, for example, news, promotional data, etc. The data management platform 110 and the data publishing platform 120 in the environment 100 may be an application that publishes data and an application that presents data, respectively.

The data management platform 110 may be run in a suitable electronic device. Here, the electronic device may be any type of mobile terminal, fixed terminal, or portable terminal, including a mobile handset, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals for these devices, or any combination thereof. In some embodiments, the data management platform 110 may also support any type of interface to the user (such as “wearable” circuitry, etc.). The servers may be of various types of computing systems/servers capable of providing computing capabilities, including but not limited to mainframes, edge computing nodes, computing devices in a cloud environment, etc.

It should be understood that the structure and function of the various elements in the environment 100 are described for exemplary goals only, and are not intended to imply any limitation on the scope of the disclosure. Some example embodiments of the present disclosure will be described in detail below with reference to examples of the accompanying drawings.

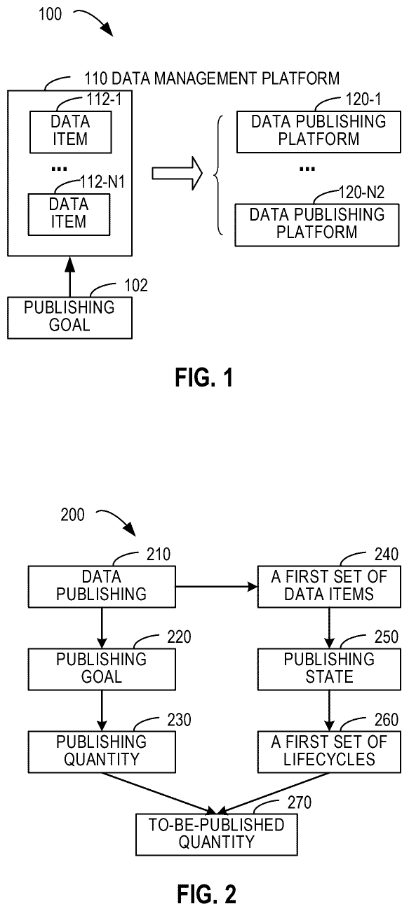

FIG. 2 illustrates a schematic diagram of an example 200 according to some embodiments of the present disclosure. The example 200 may be implemented at the data management platform 110. The example 200 is described below with reference to FIG. 1.

In the example 200, the data management platform 110 may receive data publishing 210 and a publishing goal 220 associated with the data publishing 210. For example, the data management platform 110 may receive a user (e.g., data publisher) input and determine the data publishing 210 and the publishing goal 220 based on the user input. The user input may be any suitable type of user input, such as voice, text, etc.

The data publishing 210 may indicate which data items or which types of data items are to be published, and to which platform or platforms the data items are published. The publishing goal 220 may correspond to the publishing goal 102 in FIG. 1. The data items may include media items for recommending target objects, which may be any suitable type of media item. Target objects include virtual articles (e.g., applications, music, movies, etc.) as well as real articles.

The publishing goal 220 may indicate a publishing result expected to be obtained through the data publishing (i.e., publishing data items). For example, if the data item is a data item for recommending an application, the publishing result may be that M users have downloaded the application. In some embodiments, the publishing goal 220 may also include causing an occurrence rate of events associated with the target object to meet a predetermined threshold. Events may include, for example, download events, registration events, access events, conversion events and the like associated with the target object. For example, taking an application as the target object by way of example, the download event associated with the target object may be, for example, that the user has downloaded the application, and the registration event associated with the target object may be, for example, that the user has registered the application. Taking an article as the target object by way of example, the access event associated with the target object may be, for example, that the user has viewed a detail page of the article, and the conversion event associated with the target object may be, for example, that the user adds the article to bag or the user purchases the article.

Still taking the data item as a data item for recommending a certain application by way of example, it may be understood that not every user browsing the published data item will download the application. Therefore, the occurrence rate of the download event may be a ratio of the number of users who have actually downloaded the application by browsing the data item to the total number of users who have browsed the data item. The publishing goal 220 may include, for example, that an occurrence rate of the download event associated with the application is greater than a predetermined threshold. Thus, the publishing goals may be measured in a variety of ways to meet needs of the data publisher.

The data management platform 110 may determine a publishing quantity 230 of the plurality of data items that need to be published to achieve the publishing goal 220. The data management platform 110, for instance, may determine a relational function between the publishing goal and the published data based on a historical publish target and a historical publishing quantity of the publishing of historical data. This relationship function may be any suitable function, for example, may be a power function. The data management platform 110 may determine a publishing quantity 230 based on, for example, the relational function between the publishing goal and the publishing data and the publishing goal 220.

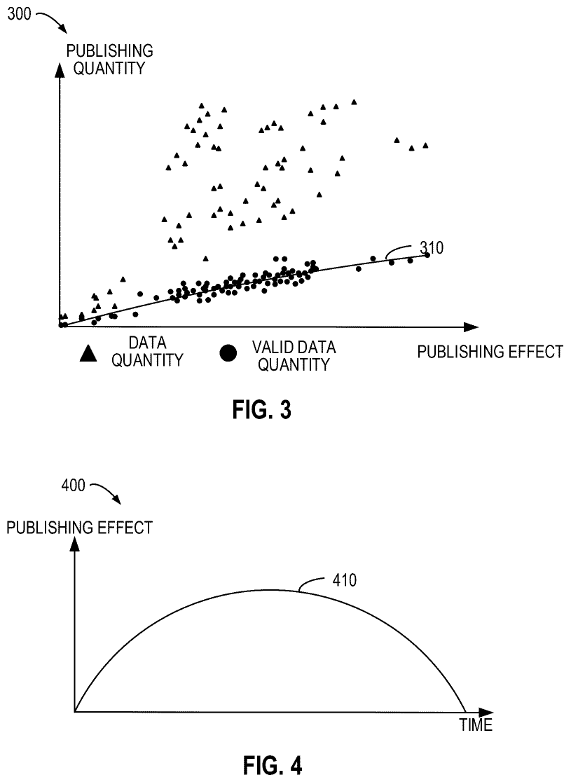

Reference is made to FIG. 3, which illustrates a schematic view of an example relationship 300 of a quantity and effect of data publishing according to some embodiments of the present disclosure. In FIG. 3, triangles may represent the quantity of data items that are actually published, and circles may represent the quantity of valid data items in a large number of data items that are published. The valid data item may include, for example, a data item having a corresponding event. For example, taking the data item is used for recommending a certain application as an example, if the user has downloaded the application through a data item, the data item is a valid data item. The data management platform 110 may determine a relational function between a valid data item quantity of valid data items and the publishing goal (i.e., curve 310 in the figure). The data management platform 110 may determine the valid data item quantity corresponding to the publishing goal 220 based on the relational function, where the valid data item number is the publishing quantity 230. This may avoid resource wastage caused by publishing large amounts of data items.

The data management platform 110 may determine a first set of lifecycles 260 of a first set of data items 240 based on a publishing state 250 of the first set of data items 240 that have been published. A first lifecycle in the first set of lifecycles 260 indicates an impact of a first data item in the first set of data items 240 on the publishing goal 220. The first set of data items 240 may include a plurality of first data items, each of which may correspond to a distinct first lifecycle. The first lifecycle, for example, may include the four phases of Online-Development-Decay-No impact. For each first data item, the data management platform 110, for example, may determine its corresponding first lifecycle based on the publishing state corresponding to the first data item (i.e., determine which of the phases of Online, Development, Decay and No impact the first data item is in).

In some embodiments, the data management platform 110 may respectively obtain a first set of time points at which the first set of data items was published, and determine, based on the first set of time points, the first set of lifecycles of the first set of data items according to a machine learning model. The first set of data items may be all data items which are currently published, and the first set of time points corresponding to a plurality of first data items in the first set of data items may be the same time point (namely, the first set of data items are published simultaneously), and may also be different time points (namely, the first set of data items are published in batches at a plurality of time points).

This machine learning model may be any suitable machine learning model for determining a lifecycle of a data item, which may include, but is not limited to, a transformer, a full convolutional network (FCN), a convolutional neural network (CNN), a recurrent neural network (RNN), etc., and the embodiments of the present disclosure are not limited in this regard. In some embodiments, the machine learning model may be, for example, a time series model.

With respect to the manner in which the machine learning model is trained, in some embodiments, the data management platform 110 may obtain a reference data item associated with reference data publishing, the reference data item being published to achieve a reference publishing goal. The data management platform 110 may determine a reference lifecycle of the reference data item based on a reference time point at which the reference data item is published and a reference publishing result produced by the reference data item after the reference time point. The data management platform 110, in turn, may update the machine learning model based on the reference time point and the reference lifecycle. The reference data item herein may be, for example, a historically published data item. The data management platform 110 may update the machine learning model using the time points and the publishing results corresponding to the historically published data items. In this way, the machine learning model may obtain a variety of knowledge in historical data to determine the lifecycle of a published data item in a more accurate and efficient manner.

With reference to FIG. 4, this figure illustrates a schematic view of an example relationship 400 of effect and time of data publishing according to some embodiments of the present disclosure. Here, the publishing effect is an impact of the data item on the publishing goal. The machine learning model may, for example, determine and update a relational function (e.g., curve 410 shown in the figure) between the publishing effect and time based on a reference publishing result and a reference time point corresponding to a reference data item. Further, at the application phase, the machine learning model may determine a first set of lifecycles of a first set of data items based on a publishing state of the first set of data items and a determined relational function between the publishing effect and time.

The data management platform 110 may determine a second quantity of a second set of data items to be published (which may also be referred to simply as a to-be-published quantity 270) based on the publishing quantity 230, the first quantity of the first set of data items 240, and the first set of lifecycles 260. In some embodiments, data items may be published in batches to ensure that published data items may have a stable impact on the publishing goal over a period of time. For example, if published data items are expected to have a stable impact on the publishing goal within one month, the data items may be published once every 10 days, and may be published three times in total. Each batch of data items may correspond to a publishing quantity corresponding to a publishing goal.

In some embodiments, the publishing goals corresponding to batches of data items may also be different. For example, if the publishing quantity corresponding to the publishing goal is X, the quantity of data items in each batch may be [X−Δ, X+Δ], where Δ may be any appropriate value, for example, 10% of X (or another proportion). Thus, the publishing quantity may be ensured to change within a certain range, and the publishing result may be ensured. The currently active data items of each batch may include data items still affecting the publishing goal among the previously published data items and the newly published data items of the batch.

For example, taking 100 as an example of the publishing quantity corresponding to the publishing goal, if the first quantity of the first set of data items is 100 and the quantity of data items corresponding the no-impact lifecycle in the first set of data items is 40, the data management platform 110 may determine that a quantity of data items to be published is 100−40=60. If the first quantity of the first set of data items is 50 and the quantity of data items corresponding to the no-impact lifecycle in the first set of data items is 20, in order to ensure the publishing goal of data items in the current batch, the data management platform 110 may determine that a quantity of data items in the first set of data items that still affect the publishing goal is 50−20=30, to further determine that a quantity of data items to be published is 100−30=70. Alternatively and/or additionally, the data items may be published in a plurality of batches step by step, thereby achieving the publishing goal within a predetermined period of time.

In some embodiments, the data management platform 110 may obtain data items to be published from a plurality of platforms, respectively. For example, the data management platform 110 may obtain a second set of data items that reach a second quantity, from a first data source and a second data source, and publish the second set of data items such that the publishing goal is achieved. In particular, the data management platform 110 may determine a first quality distribution for a first plurality of reference data items provided by the first data source and a second quality distribution for a second plurality of reference data items provided by the second data source. In other words, more data items may be selected from a data source that provides better data items, and fewer data items may be selected from a data source that provides general quality data items, according to the quality of data items provided by respective data sources.

With respect to the particular manner of determining the first quality distribution, in some embodiments, the data management platform 110 may separately obtain a first plurality of quality ratings for a first plurality of reference data items (e.g., a plurality of data items historically obtained from the first data source). The data management platform 110 may determine the first quality distribution based on a ratio of at least a portion of the first plurality of reference data items to the first plurality of reference data items, the quality rating of the at least a portion of the reference data items being higher than a threshold rating.

Each of the first plurality of quality ratings herein may be determined, for example, based on an occurrence rate of an event associated with a target object corresponding to the respective data item. For example, if a given data item is a data item for an article, the quality rating for the data item may be determined based on the occurrence rate (i.e., conversion rate) of a conversion event for the article corresponding to the data item. The higher the occurrence rate is, the higher the corresponding quality rating is.

Similarly, the data management platform 110 may obtain a second plurality of quality ratings for a second plurality of reference data items (e.g., a plurality of data items historically obtained from the second data source), respectively, and determine the second quality distribution based on a ratio of at least a portion of the second plurality of reference data items to the second plurality of reference data items, the quality rating of the at least a portion of the reference data items being higher than a threshold rating. Thus, the quality of a data source may be determined based on the quality distribution of data items, so that more data items may be obtained from a premium data source.

The data management platform 110 may determine, based on the first and second quality distributions, a ratio between a quantity of data items obtained from the first data source and a quantity of data items obtained from the second data source, and obtain, based on the ratio, the first plurality of data items from the first data source and the second plurality of data items from the second data source. Here, the sum of the first plurality of data items and the second plurality of data items may, for example, satisfy the second quantity (i.e., satisfy the to-be-published quantity 270). In an example where the to-be-published quantity is 60, the sum of the first plurality of data items and the second plurality of data items may be, for example, 60. Alternatively or additionally, in some embodiments, the sum of the first plurality of data items and the second plurality of data items may be, for example, [60−Δ, 60+Δ], where Δ may be, for example, 6. It will be appreciated that if a plurality of data sources are included, the sum of a plurality of data items that the data management platform 110 obtains from the plurality of data sources satisfies the second quantity.

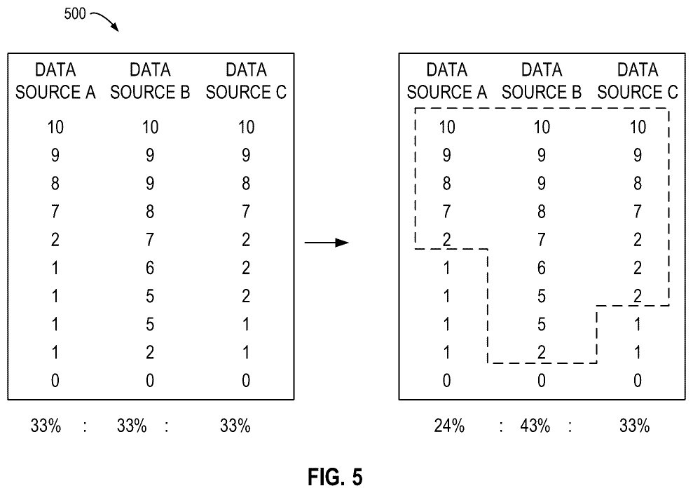

With reference to FIG. 5, this figure illustrates a schematic view of an example 500 of obtaining data items according to some embodiments of the present disclosure. The example 500 includes three data sources A, B and C. The data management platform 110 may obtain 10 reference data items from each data source, and may rank the 10 reference data items corresponding to each data source in descending order of quality ratings. Taking the data source A as an example, the 10 quality ratings corresponding to the 10 reference data items obtained by the data management platform 110 from the data source A may be 10, 9, 8, 7, 2, 1, 1, 1, 1 and 0 respectively. If the threshold rating is 2, the first 5 reference data items corresponding to the data source A meet (for example, greater than or equal to) the threshold rating.

Similarly, the first 9 reference data items corresponding to the data source B meet the threshold rating, and the first 7 reference data items corresponding to the data source C meet the threshold rating. Therefore, the quantities of reference data items satisfying the threshold rating in the data sources A, B and C are 5, 9 and 7, respectively. In turn, the data management platform 110 may determine that a ratio at which data items are obtained from the three data sources is 24%: 43%: 33%, based on the respective quantities of reference data items in the data sources A, B, C that meet the threshold rating. If the second quantity is 100, the data management platform 110 may obtain 24 data items from the data source A, 43 data items from the data source B, and 33 data items from the data source C. Thus, it is guaranteed that more data items are obtained from data sources with a high quality rating and fewer data items are obtained from data sources with a low quality rating, thereby improving the quality of the obtained data items.

With respect to the particular manner of publishing the second set of data items, in some embodiments, the data management platform 110 may publish the second set of data items directly. For example, if the to-be-published quantity 270 is 60, then the second set of data items may include 60 data items, and the data management platform 110 may directly publish the 60 data items. Alternatively or additionally, in some embodiments, the data management platform 110 may also replace the first data item with a second data item in the second set of data items in response to determining that the first lifecycle of the first data item indicates that the impact of the first data item on the publishing goal is less than a predetermined threshold impact. For example, if the lifecycle corresponding to the first data item is no-impact, the data management platform 110 may directly replace the first data item with the second data item. In this way, non-active data items that no longer exert any impact may be removed, thereby reducing storage and computational consumption caused by the non-active data items.

In some embodiments, at least any of the second quantity of the second set of data items and the first quality distribution is determined at a predetermined time interval. That is, the data management platform 110 may periodically determine the to-be-published quantity 270 and periodically determine the ratio of data items to be obtained from each of the plurality of data sources. The period here may be predefined, for example, one day, three days, one week, ten days, etc. For example, taking one day as an example of the period, and the data management platform 110 may determine the to-be-published quantity 270 once a day and/or the ratio of the data items obtained from each data source once a day. Thus, it may be guaranteed that the data management platform 110 may adjust the publishing of data items based on the real-time effect of the data publishing, which helps to improve the effect of the data publishing and ensuring the publishing quality.

To sum up, according to embodiments of the present disclosure, the quantity of data items to be published may be determined based on the lifecycle of the published data items and the determined to-be-published quantity. This helps to flexibly adjust of the quantity of data publishing, reduce resource waste, and improve the data publishing effect.

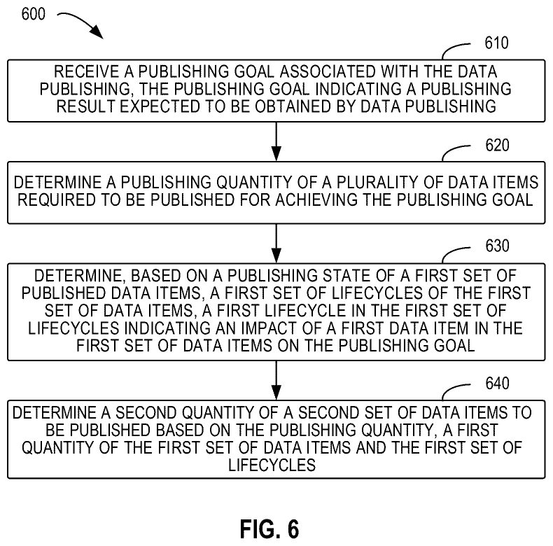

FIG. 6 illustrates a flowchart of a process 600 for managing data publishing according to some embodiments of the disclosure. The process 600 may be implemented at the data management platform 110. The process 600 is described below with reference to FIG. 1.

At block 610, the data management platform 110 receives a publishing goal associated with the data publishing, the publishing goal indicating a publishing result expected to be obtained by data publishing.

At block 620, the data management platform 110 determines a publishing quantity of a plurality of data items required to be published for achieving the publishing goal.

At block 630, the data management platform 110 determines, based on a publishing state of a first set of published data items, a first set of lifecycles of the first set of data items, a first lifecycle in the first set of lifecycles indicating an impact of a first data item in the first set of data items on the publishing goal.

At block 640, the data management platform 110 determines a second quantity of a second set of data items to be published based on the publishing quantity, a first quantity of the first set of data items and the first set of lifecycles.

In some embodiments, determining the first set of lifecycles comprises: obtaining a first set of time points at which the first set of data items are published, respectively; and determining, based on the first set of time points, the first set of lifecycles of the first set of data items according to a machine learning model.

In some embodiments, the machine learning model is obtained by: obtaining a reference data item associated with reference data publishing, the reference data item being published to achieve a reference publishing goal; determining a reference lifecycle of the reference data item based on a reference time point at which the reference data item is published and a reference publishing result produced by the reference data item after the reference time point; and updating the machine learning model based on the reference time point and the reference lifecycle.

In some embodiments, the process 600 further comprises: obtaining from a first data source and a second data source the second set of data items that satisfy the second quantity; and publishing the second set of data items to cause the publishing goal to be achieved.

In some embodiments, obtaining the second set of data items comprises: determining a first quality distribution for a first plurality of reference data items provided by the first data source and a second quality distribution for a second plurality of reference data items provided by the second data source; determining, based on the first and second quality distributions, a ratio between a quantity of data items obtained from the first data source and a quantity of data items obtained from the second data source; and obtaining a first plurality of data items from the first data source and a second plurality of data items from the second data source, respectively, according to the ratio.

In some embodiments, determining the first quality distribution comprises: obtaining a first plurality of quality ratings for the first plurality of reference data items, respectively; and determining the first quality distribution based on a ratio between at least a portion of reference data items of the first plurality of reference data items and the first plurality of reference data items, a quality rating of the at least a portion of reference data items being higher than a threshold rating.

In some embodiments, a sum of the first plurality of data items and the second plurality of data items satisfies the second quantity.

In some embodiments, publishing the second set of data items further comprises: in response to determining that the first lifecycle of the first data item indicates that the impact of the first data item on the publishing goal is below a predetermined threshold impact, replacing the first data item with a second data item in the second set of data items.

In some embodiments, at least any of the second quantity of the second set of data items and the first quality distribution is determined at a predetermined time interval.

In some embodiments, the data item comprises a media item for recommending a target object, the target object comprising a virtual item and a real item, and the publishing goal comprising causing an occurrence rate of events associated with the target object to meet a predefined threshold.

In some embodiments, the events comprise at least any one of a download event, a registration event, an access event, and a conversion event associated with the target object.

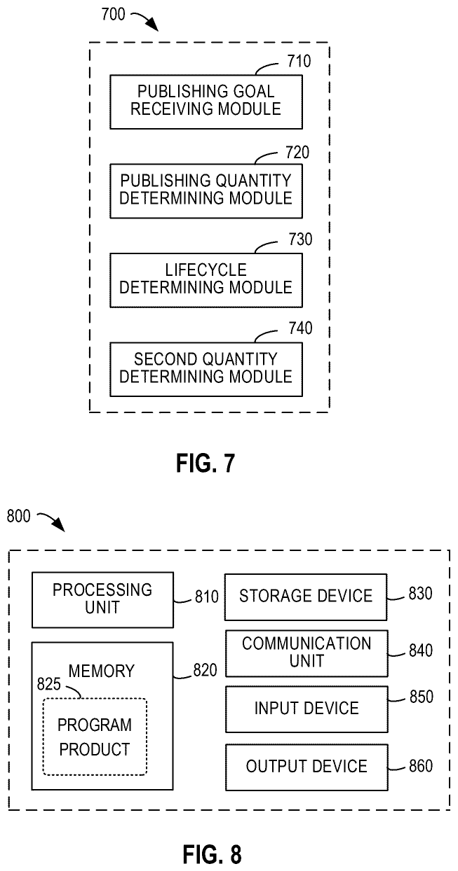

An apparatus for managing data publishing is further provided according to some embodiments of the present disclosure. FIG. 7 illustrates a block diagram of an apparatus 700 for managing data publishing according to some embodiments of the present disclosure. The apparatus 700 may be implemented as or included in the data management platform 110. The various modules/components in the apparatus 700 may be implemented by hardware, software, firmware, or any combination thereof.

As shown in FIG. 7, the apparatus 700 comprises a publishing goal receiving module 710 configured for receiving a publishing goal associated with the data publishing, the publishing goal indicating a publishing result expected to be obtained by data publishing. The apparatus 700 further comprises a publishing quantity determining module 720 configured for determining a publishing quantity of a plurality of data items required to be published for achieving the publishing goal. The apparatus 700 further comprises a lifecycle determining module 730 configured for determining, based on a publishing state of a first set of published data items, a first set of lifecycles of the first set of data items, a first lifecycle in the first set of lifecycles indicating an impact of a first data item in the first set of data items on the publishing goal. The apparatus 700 further comprises a second quantity determining module 740 configured for determining a second quantity of a second set of data items to be published based on the publishing quantity, a first quantity of the first set of data items and the first set of lifecycles.

In some embodiments, the lifecycle determining module 730 comprises: a time point obtaining module configured for separately obtaining a first set of time points at which the first set of data items are published; and a first cycle determining module configured for determining, based on the first set of time points, the first set of lifecycles of the first set of data items according to a machine learning model.

In some embodiments, the machine learning model is obtained by: obtaining a reference data item associated with reference data publishing, the reference data item being published to achieve a reference publishing goal; determining a reference lifecycle of the reference data item based on a reference time point at which the reference data item is published and a reference publishing result produced by the reference data item after the reference time point; and updating the machine learning model based on the reference time point and the reference lifecycle.

In some embodiments, the apparatus 700 further comprises: a data item obtaining module configured for obtaining the second set of data items from a first data source and a second data source that satisfy the second quantity; and a data item publishing module configured for publishing the second set of data items to cause the publishing goal to be achieved.

In some embodiments, the data item obtaining module comprises: a distribution determining module configured for determining a first quality distribution for a first plurality of reference data items provided by the first data source and a second quality distribution for a second plurality of reference data items provided by the second data source; a ratio determining module configured for determining, based on the first and second quality distributions, a ratio between a quantity of data items obtained from the first data source and a quantity of data items obtained from the second data source; and a first data item obtaining module configured for obtaining a first plurality of data items from the first data source and a second plurality of data items from the second data source, respectively, according to the ratio.

In some embodiments, the distribution determining module comprises: a rating obtaining module configured for obtaining a first plurality of quality ratings for the first plurality of reference data items, respectively; and a quality distribution determining module configured for determining the first quality distribution based on a ratio between at least a portion of reference data items of the first plurality of reference data items and the first plurality of reference data items, a quality rating of the at least a portion of reference data items being higher than a threshold rating.

In some embodiments, a sum of the first plurality of data items and the second plurality of data items satisfies the second quantity.

In some embodiments, the data item publishing module further comprises: a data item replacing module configured for, in response to determining that the first lifecycle of the first data item indicates that the impact of the first data item on the publishing goal is below a predetermined threshold impact, replacing the first data item with a second data item in the second set of data items.

In some embodiments, at least any of the second quantity of the second set of data items and the first quality distribution is determined at a predetermined time interval.

In some embodiments, the data item comprises a media item for recommending a target object, the target object comprising a virtual item and a real item, and the publishing goal comprising causing an occurrence rate of events associated with the target object to meet a predefined threshold.

In some embodiments, the events comprise at least any one of a download event, a registration event, an access event, and a conversion event associated with the target object.

The units and/or modules included in apparatus 700 may be implemented in a variety of ways, including software, hardware, firmware, or any combination thereof. In some embodiments, one or more units and/or modules may be implemented using software and/or firmware, such as machine-executable instructions stored on a storage medium. In addition to or as an alternative to machine executable instructions, some or all of the units and/or modules in the apparatus 700 may be implemented, at least in part, by one or more hardware logic components. By way of example, and not limitation, illustrative types of hardware logic components that may be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

It should be understood that one or more steps of the above methods may be performed by a suitable electronic device or combination of electronic devices. Such an electronic device or combination of electronic devices may include, for example, the data management platform 110 in FIG. 1.

FIG. 8 illustrates a block diagram of an electronic device 800 that may implement one or more embodiments of the present disclosure. It should be understood that the electronic device 800 shown in FIG. 8 is only exemplary and shall not constitute any limitation on the functions and scope of the embodiments described herein. The electronic device 800 shown in FIG. 8 may be used to implement the data management platform 110 in FIG. 1, and/or the apparatus 700 in FIG. 7.

As shown in FIG. 8, the electronic device 800 is in the form of a general purpose computing device. Components of the electronic device 800 may include, but are not limited to, one or more processors or processing units 810, a memory 820, a storage device 830, one or more communication units 840, one or more input devices 850, and one or more output devices 860. The processing unit 810 may be a physical or virtual processor and may execute various processing based on the programs stored in the memory 820. In a multi-processor system, a plurality of processing units executes computer-executable instructions in parallel to enhance parallel processing capability of the electronic device 800.

The electronic device 800 usually includes a plurality of computer storage mediums. Such mediums may be any attainable medium accessible by the electronic device 800, including but not limited to, a volatile and non-volatile medium, a removable and non-removable medium. The memory 820 may be a volatile memory (e.g., a register, a cache, a Random Access Memory (RAM)), a non-volatile memory (such as, a Read-Only Memory (ROM), an Electrically Erasable Programmable Read-Only Memory (EEPROM), flash), or any combination thereof. The storage device 830 may be a removable or non-removable medium, and may include a machine-readable medium (e.g., a memory, a flash drive, a magnetic disk) or any other medium, which may be used for storing information and/or data (e.g., training data for training) and be accessed within the computing device 800.

The electronic device 800 may further include additional removable/non-removable, volatile/non-volatile storage mediums. Although not shown in FIG. 8, there may be provided a disk drive for reading from or writing into a removable and non-volatile disk (e.g., “floppy disk”) and an optical disc drive for reading from or writing into a removable and non-volatile optical disc. In such cases, each drive may be connected to a bus (not shown) via one or more data medium interfaces. The memory 820 may include a computer program product 825 having one or more program modules, and these program modules are configured for performing various methods or acts of various implementations of the present disclosure.

The communication unit 840 implements communication with another computing device via a communication medium. Additionally, functions of components of the electronic device 800 may be realized by a single computing cluster or a plurality of computing machines, and these computing machines may communicate through communication connections. Therefore, the electronic device 800 may operate in a networked environment using a logic connection to one or more other servers, a networked Personal Computer (PC) or a further general network node.

The input device 850 may be one or more various input devices, such as a mouse, a keyboard, a trackball, a voice-input device, and the like. The output device 860 may be one or more output devices, e.g., a display, a loudspeaker, a printer, and so on. The electronic device 800 may also communicate through the communication unit 840 with one or more external devices (not shown) as required, where the external device, e.g., a storage device, a display device, and so on, communicates with one or more devices that enable users to interact with the electronic device 800, or with any device (such as a network card, a modem, and the like) that enable the electronic device 800 to communicate with one or more other computing devices. Such communication may be executed via an Input/Output (I/O) interface (not shown).

According to the example implementations of the present disclosure, a computer-readable storage medium is provided, on which computer-executable instructions are stored, wherein the computer-executable instructions are executed by a processor to implement the method described above. According to the example implementations of the present disclosure, a computer program product is further provided, which is tangibly stored on a non-transient computer-readable medium and includes computer-executable instructions, which are executed by a processor to implement the method described above.

Aspects of the present disclosure are described herein with reference to flowchart illustrations and/or block diagrams of methods, apparatus (systems), and computer program products according to implementations of the invention. It will be understood that each block of the flowchart illustrations and/or block diagrams, and combinations of blocks in the flowchart illustrations and/or block diagrams, may be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that may direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods and computer program products according to various implementations of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts, or combinations of special purpose hardware and computer instructions.

The descriptions of the various implementations of the present disclosure have been presented for purposes of illustration, but are not intended to be exhaustive or limited to implementations disclosed. Many modifications and variations will be apparent to those of ordinary skill in the art without departing from the scope and spirit of the described implementations. The terminology used herein was chosen to best explain the principles of implementations, the practical application or technical improvement over technologies found in the marketplace, or to enable others of ordinary skill in the art to understand implementations disclosed herein.

1. A method for managing data publishing, comprising:
receiving a publishing goal associated with the data publishing, the publishing goal indicating a publishing result expected to be obtained by data publishing;
determining a publishing quantity of a plurality of data items required to be published for achieving the publishing goal;
determining, based on a publishing state of a first set of published data items, a first set of lifecycles of the first set of data items, a first lifecycle in the first set of lifecycles indicating an impact of a first data item in the first set of data items on the publishing goal; and
determining a second quantity of a second set of data items to be published based on the publishing quantity, a first quantity of the first set of data items and the first set of lifecycles.

2. The method of claim 1, wherein determining the first set of lifecycles comprises:
obtaining a first set of time points at which the first set of data items are published, respectively; and
determining, based on the first set of time points, the first set of lifecycles of the first set of data items according to a machine learning model.

3. The method of claim 2, wherein the machine learning model is obtained by:
obtaining a reference data item associated with reference data publishing, the reference data item being published to achieve a reference publishing goal;
determining a reference lifecycle of the reference data item based on a reference time point at which the reference data item is published and a reference publishing result produced by the reference data item after the reference time point; and
updating the machine learning model based on the reference time point and the reference lifecycle.

4. The method of claim 1, further comprising:
obtaining, from a first data source and a second data source, the second set of data items that satisfy the second quantity; and
publishing the second set of data items to cause the publishing goal to be achieved.

5. The method of claim 4, wherein obtaining the second set of data items comprises:
determining a first quality distribution for a first plurality of reference data items provided by the first data source and a second quality distribution for a second plurality of reference data items provided by the second data source;
determining, based on the first and second quality distributions, a ratio between a quantity of data items obtained from the first data source and a quantity of data items obtained from the second data source; and
obtaining, according to the ratio, a first plurality of data items from the first data source and a second plurality of data items from the second data source, respectively.

6. The method of claim 5, wherein determining the first quality distribution comprises:
obtaining a first plurality of quality ratings for the first plurality of reference data items, respectively; and
determining the first quality distribution based on a ratio between at least a portion of reference data items of the first plurality of reference data items and the first plurality of reference data items, a quality rating of the at least a portion of reference data items being higher than a threshold rating.

7. The method of claim 5, wherein a sum of the first plurality of data items and the second plurality of data items satisfies the second quantity.

8. The method of claim 4, wherein publishing the second set of data items further comprises: in response to determining that the first lifecycle of the first data item indicates that the impact of the first data item on the publishing goal is below a predetermined threshold impact, replacing the first data item with a second data item in the second set of data items.

9. The method of claim 6, wherein at least any of the second quantity of the second set of data items and the first quality distribution is determined at a predetermined time interval.

10. The method of claim 1, wherein the data item comprises a media item for recommending a target object, the target object comprising a virtual item and a real item, and the publishing goal comprising causing an occurrence rate of events associated with the target object to meet a predefined threshold.

11. The method of claim 10, wherein the events comprise at least any of: a download event, a registration event, an access event, and a conversion event associated with the target object.

12. An electronic device, comprising:
at least one processing unit; and
at least one memory coupled to the at least one processing unit and storing instructions executable by the at least one processing unit, the instructions, when executed by the at least one processing unit, causing the electronic device to perform the method for managing data publishing, comprising:
receiving a publishing goal associated with the data publishing, the publishing goal indicating a publishing result expected to be obtained by data publishing;
determining a publishing quantity of a plurality of data items required to be published for achieving the publishing goal;
determining, based on a publishing state of a first set of published data items, a first set of lifecycles of the first set of data items, a first lifecycle in the first set of lifecycles indicating an impact of a first data item in the first set of data items on the publishing goal; and
determining a second quantity of a second set of data items to be published based on the publishing quantity, a first quantity of the first set of data items and the first set of lifecycles.

13. The device of claim 12, wherein determining the first set of lifecycles comprises:
obtaining a first set of time points at which the first set of data items are published, respectively; and
determining, based on the first set of time points, the first set of lifecycles of the first set of data items according to a machine learning model.

14. The device of claim 13, wherein the machine learning model is obtained by:
obtaining a reference data item associated with reference data publishing, the reference data item being published to achieve a reference publishing goal;
determining a reference lifecycle of the reference data item based on a reference time point at which the reference data item is published and a reference publishing result produced by the reference data item after the reference time point; and
updating the machine learning model based on the reference time point and the reference lifecycle.

15. The device of claim 12, wherein the method further comprises:
obtaining, from a first data source and a second data source, the second set of data items that satisfy the second quantity; and
publishing the second set of data items to cause the publishing goal to be achieved.

16. The device of claim 15, wherein obtaining the second set of data items comprises:
determining a first quality distribution for a first plurality of reference data items provided by the first data source and a second quality distribution for a second plurality of reference data items provided by the second data source;
determining, based on the first and second quality distributions, a ratio between a quantity of data items obtained from the first data source and a quantity of data items obtained from the second data source; and
obtaining, according to the ratio, a first plurality of data items from the first data source and a second plurality of data items from the second data source, respectively.

17. The device of claim 16, wherein determining the first quality distribution comprises:
obtaining a first plurality of quality ratings for the first plurality of reference data items, respectively; and
determining the first quality distribution based on a ratio between at least a portion of reference data items of the first plurality of reference data items and the first plurality of reference data items, a quality rating of the at least a portion of reference data items being higher than a threshold rating.

18. The device of claim 16, wherein a sum of the first plurality of data items and the second plurality of data items satisfies the second quantity.

19. The device of claim 15, wherein publishing the second set of data items further comprises:
in response to determining that the first lifecycle of the first data item indicates that the impact of the first data item on the publishing goal is below a predetermined threshold impact, replacing the first data item with a second data item in the second set of data items.

20. A non-transitory computer program product, comprising a computer program, wherein the computer program, when executed by a processor, implements the method for managing data publishing, comprising:
receiving a publishing goal associated with the data publishing, the publishing goal indicating a publishing result expected to be obtained by data publishing;
determining a publishing quantity of a plurality of data items required to be published for achieving the publishing goal;
determining, based on a publishing state of a first set of published data items, a first set of lifecycles of the first set of data items, a first lifecycle in the first set of lifecycles indicating an impact of a first data item in the first set of data items on the publishing goal; and
determining a second quantity of a second set of data items to be published based on the publishing quantity, a first quantity of the first set of data items and the first set of lifecycles.
